(19) United States
(12) Patent Application Publication
(10) Pub. No.: US 2026/0282117 A1
(43) Pub. Date: Sep. 17, 2026

(54) COMMUNICATION CONTROL DEVICE, BASE STATION, AND COMMUNICATION CONTROL METHOD

(71) Applicant: Sony Group Corporation, Tokyo (JP)

(72) Inventor: Ryota KIMURA, Tokyo (JP)

(73) Assignee: Sony Group Corporation, Tokyo (JP)

(21) Appl. No.: 19/168,191

(22) PCT Filed: Mar. 22, 2024
(86) PCT No.: PCT/JP2024/011410

§ 371 Date: Sep. 23, 2025

(30) Foreign Application Priority Data
Mar. 31, 2023 (JP) 2023-059162

(51) Int. Cl. H04W 74/08; H04B 17/318; H04W 52/36

(52) U.S. Cl. CPC H04W 74/0875; H04B 17/328; H04W 52/367

(57) ABSTRACT

There is provided a communication control device capable of preventing or suppressing radio wave interference between base stations when a plurality of base stations uses the same wireless communication resource. The communication control device includes: a reception unit that receives information regarding priority of a first base station and a second base station; a determination unit that determines priority between the first base station and the second base station on the basis of the information regarding the priority; a calculation unit that calculates radio wave areas of the first base station and the second base station on the basis of the priority; a decision unit that decides a wireless parameter of at least one of the first base station or the second base station on the basis of the radio wave areas; and a first transmission unit that transmits the wireless parameter to a corresponding base station.

### TECHNICAL FIELD

The present disclosure relates to a communication control device, a base station, and a communication control method.

### BACKGROUND ART

As a technology for sharing the same wireless communication resource by a plurality of communication devices, for example, dynamic frequency sharing (Dynamic Spectrum Access (DSA)) is known. In the conventional DSA, interference of a radio wave between communication devices is prevented or suppressed by appropriate setting of wireless parameters of a plurality of communication devices using the same frequency resource.

### CITATION LIST

### Patent Document

Patent Document 1: Japanese Patent Application Laid-Open No. 2011-166721

### SUMMARY OF THE INVENTION

### Problems to be Solved by the Invention

An object of the present disclosure is to provide a communication control device capable of preventing or suppressing interference of a radio wave between base stations when a plurality of base stations uses the same wireless communication resource.

### Solutions to Problems

In order to solve the above problem, a communication control device according to the present disclosure includes: a first reception unit that receives information regarding priority of a first base station and a second base station; a determination unit that determines priority between the first base station and the second base station on the basis of the information regarding the priority; a calculation unit that calculates radio wave areas of the first base station and the second base station on the basis of the priority; a decision unit that decides a wireless parameter of at least one of the first base station or the second base station on the basis of the radio wave areas; and a first transmission unit that transmits the wireless parameter to a corresponding base station.

Furthermore, a base station according to the present disclosure includes: a second transmission unit that transmits information regarding priority of the base station to a communication control device; a second reception unit that receive a wireless parameter from the communication control device; and a setting unit that performs operation setting of the base station according to the wireless parameter.

Furthermore, a communication control method according to the present disclosure includes: a step of receiving information regarding priority of a first base station and a second base station; a step of determining priority between the first base station and the second base station on the basis of the information regarding the priority; a step of calculating radio wave areas of the first base station and the second base station on the basis of the priority; a step of deciding a wireless parameter of at least one of the first base station or the second base station on the basis of the radio wave areas; and a step of transmitting the wireless parameter to a corresponding base station.

### BRIEF DESCRIPTION OF DRAWINGS

FIG. 1 is a diagram illustrating a configuration example of a wireless communication system according to a first embodiment.

FIG. 2 is a diagram illustrating five examples in which a first base station and a second base station use the same frequency band.

FIG. 3 is a diagram illustrating five examples in which the first and second base stations use the same time period.

FIG. 4 is a diagram illustrating a detailed configuration of a communication control device.

FIG. 5A is a diagram illustrating a detailed configuration of a base station.

FIG. 5B is a diagram illustrating a detailed configuration of a base station.

FIG. 6 is a sequence diagram illustrating a communication control protocol between the communication control device and the first and second base stations.

FIG. 7 is an example of a coverage area and an adjustment target zone of a base station.

FIG. 8 is an example of received signal strengths of the coverage area and the adjustment target zone.

FIG. 9 is a diagram illustrating a typical case.

FIG. 10 is a diagram illustrating a typical case.

### MODE FOR CARRYING OUT THE INVENTION

Hereinafter, an embodiment of the present disclosure will be described in detail with reference to the drawings. In the drawings, the same or corresponding elements are denoted by the same reference numerals, and detailed description thereof is omitted as appropriate.

### First Embodiment

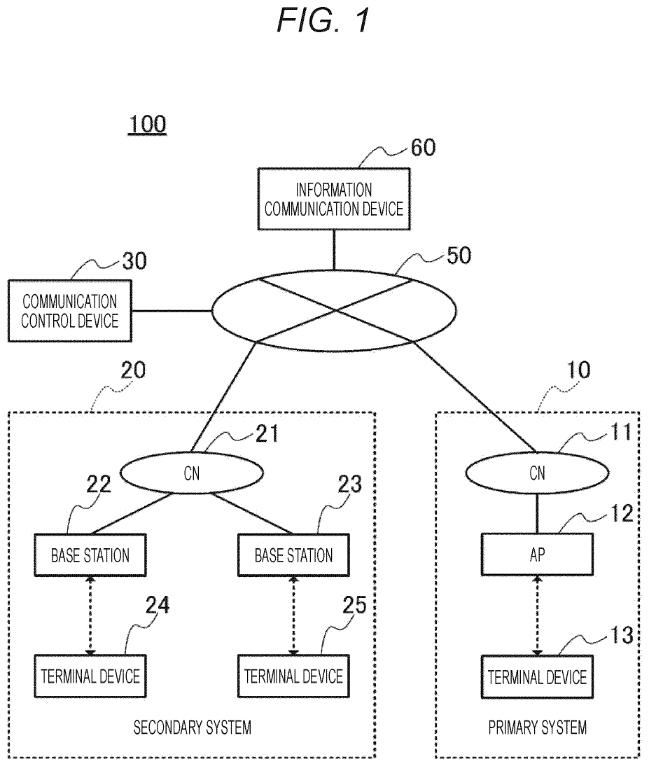

FIG. 1 is a diagram illustrating a configuration of a wireless communication network 100 according to a first embodiment of the present disclosure. The wireless communication network 100 includes a primary system 10, a secondary system 20, and a communication control device 30, which are communicably connected to each other via an Internet line 50. Furthermore, the wireless communication network 100 may include an information recording device 60.

In the present disclosure, the primary system 10 and the secondary system 20 may be, for example, a cellular system such as 3G/4G/5G, local 5G, private 5G, beyond 5G, or 6G. Alternatively, the primary system 10 and the secondary system 20 may be, for example, a wireless LAN system such as WLAN or Wi-Fi. However, the primary system 10 and the secondary system 20 are not limited thereto, and may be, for example, an LOT communication system (LPWA, Wi-SUN, Zigbee, Sigfox, LoRa, or the like), a TV broadcasting system (terrestrial broadcasting, satellite broadcasting, relay material transmission (FPU: Field Pickup Unit), or the like), a defense and military communication system, a satellite communication system, an air traffic control communication system, or the like.

In the first embodiment, the primary system 10 is a local 5G cellular system, and includes a core network 11, a base station 12, and a terminal device 13. The core network 11 is, for example, an Evolved Packet Core (EPC), 5G Core (5GC), or the like. The core network 11 is connected to the Internet line 50 in a wired or wireless manner. The base station 12 is connected to the Internet line 50 in a wired or wireless manner. The terminal device 13 is, for example, a user equipment (UE), a mobile phone, a smartphone, a smart watch, smart glasses, a smart device, or the like. The base station 12 and the terminal device 13 can communicate with each other by wireless communication.

The secondary system 20 is also a local 5G cellular system and includes a core network 21, base stations 22 and 23, and terminal devices 24 and 25. The core network 21 is, for example, EPC or 5GC. The core network 21 is connected to the Internet line 50 in a wired or wireless manner. The base stations 22 and 23 are connected to the Internet line 50 in a wired or wireless manner. The terminal devices 24 and 25 each are, for example, a UE, a mobile phone, a smartphone, a smartwatch, smart glasses, a smart device, or the like. The base stations 22 and 23 and the terminal devices 24 and 25 can communicate with each other by wireless communication.

The communication control device 30 decides wireless parameters of the base stations 22 and 23 included in the secondary system 20 so that radio wave interference from the secondary system 20 to the primary system 10 is prevented or suppressed when the primary system 10 and the secondary system 20 use the same wireless communication resource.

Furthermore, the communication control device 30 decides the wireless parameter of at least one of the base station 22 or 23 so that radio wave interference does not occur between the base stations 22 and 23 when the base stations 22 and 23 of the local 5G included in the secondary system 20 use the same wireless communication resource.

The communication control device 30 is connected to the Internet line 50 in a wired or wireless manner. The communication control device 30 can communicate with the base station 12 included in the primary system 10 via the Internet line 50. The communication control device 30 can communicate with the base stations 22 and 23 included in the secondary system 20 via the Internet line 50. Furthermore, in a case where the information recording device 60 is present, the communication control device 30 can communicate with the information recording device 60 via the Internet line 50.

The information recording device 60 records and stores information on the base station 12 included in the primary system 10, the base stations 22 and 23 included in the secondary system 20, and the communication control device 30. The information recording device 60 is, for example, a system operation adjustment system that uses a general radio station supervising system (PARTNER), a TV white space, and the like in Japan, an FCC Universal Licensing System (ULS), an Equipment Authorization System (EAS), or an Informing Incumbent Portal used in CBRS, in the United States, or the like. The information recording device 60 is connected to the Internet line 50 in a wired or wireless manner.

In the wireless communication network 100 of FIG. 1, the numbers of the primary systems 10 and the secondary systems 20 each are only required to be one or more, and may be two or more. The number of communication devices included in each of the primary system 10 and the secondary system 20 is also only required to be one or more. The number of the communication control devices 30 is also only required to be one or more. Furthermore, in a case where the information recording device 60 is present, the number of the information recording devices 60 may be one, or two or more.

### (Relationship Between Frequency Bands Used by Two Base Stations)

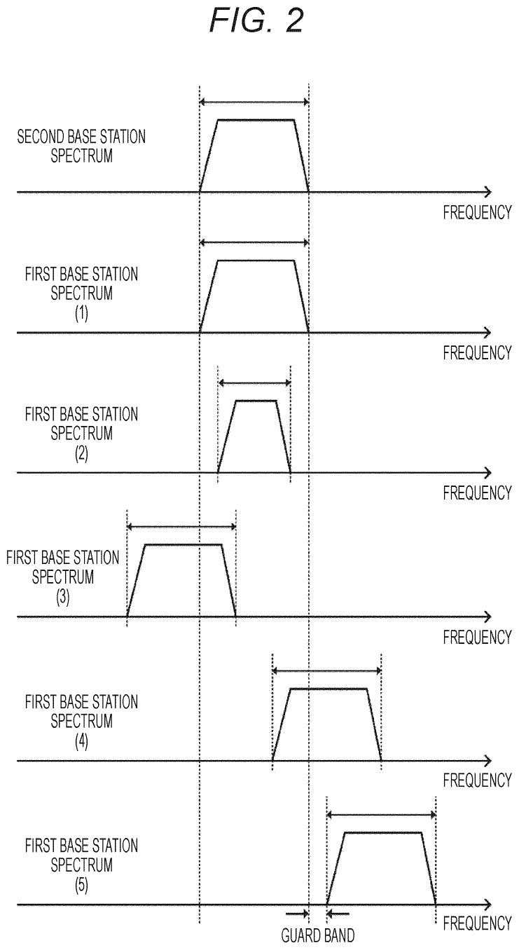

In the first embodiment, two base stations of the local 5G use the same frequency band, or frequency channel or spectrum. FIG. 2 illustrates five examples in which a first base station and a second base station of the local 5G use the same frequency band. These are all “using the same frequency band”, and there is a possibility that radio wave interference from the first base station to the second base station occurs.

In FIGS. 2, (1) and (2) are examples in which the whole of a frequency band used by the first base station is included in a frequency band of the second base station. In FIGS. 2, (3) and (4) are examples in which a part of the frequency band used by the first base station overlaps the frequency band of the second base station. In FIG. 2, (5) is an example in which the frequency band used by the first base station and the frequency band of the second base station do not overlap each other, but a gap between the frequency bands, for example, a guard band is less than or equal to a predetermined width. In this case, there is a possibility that out-of-band radiation of a radio wave emitted by the first base station interferes with the second base station.

To summarize the above, the fact that the first and second base stations use the same frequency band can be expressed as follows.

$${F}_{2 , Lower} \leq {F}_{1 , Lower} and {F}_{1 , Upper} \leq {F}_{2 , Upper} \qquad ( ( 1 ) and ( 2 ) of FIG . 2 )$$

$${F}_{1 , Lower} \leq {F}_{2 , Lower} and {F}_{2 , Lower} \leq {F}_{1 , Upper} \qquad ( ( 3 ) of FIG . 2 )$$

$${F}_{1 , Lower} \leq {F}_{2 , Upper} and {F}_{2 , Upper} \leq {F}_{1 , Upper} \qquad ( ( 4 ) of FIG . 2 )$$

$$0 \leq {F}_{2 , Lower} - {F}_{1 , Upper} \leq {B}_{1 , 2 , Guard} or 0 \leq {F}_{1 , Lower} - {F}_{2 , Upper} \leq {B}_{1 , 2 , Guard} \qquad ( ( 5 ) of FIG . 2 )$$

However, in the above expression, F_{2,Lower} and F_{2,Upper} are a lower limit and an upper limit (F_{2,Lower}≤F_{2,Upper}) of the frequency band used by the second base station, F_{1,Lower} and F_{1,Upper} are a lower limit and an upper limit (F_{1,Lower}≤F_{1,Upper}) of the frequency band used by the first base station, and B_{1,2,Guard} is a predetermined guard band width (0≤B_{1,2,Guard}) with which the same frequency band is considered to be used.

### (Relationship Between Time Periods Used by Two Base Stations)

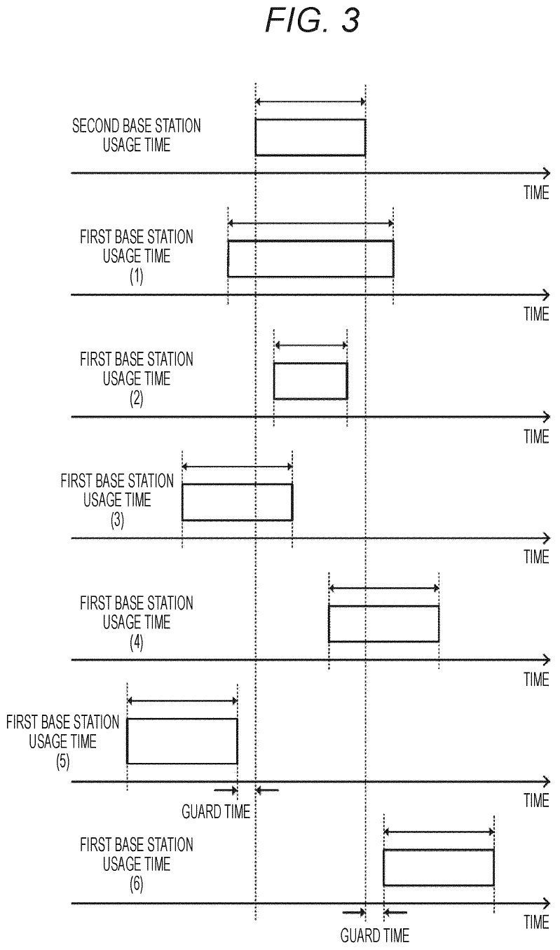

A time period or a time slot can be considered similarly to the frequency band. FIG. 3 illustrates five examples in which the first and second base stations of the local 5G use the same time period. These are all “using the same time period”, and there is a possibility that interference of radio waves from the first base station to the second base station occurs.

In FIG. 3, (1) is an example in which a time period used by the first base station includes the whole of a time period of the second base station. In FIG. 3, (2) is an example in which the whole of the time period used by the first base station is included in the time period of the second base station. In FIGS. 3, (3) and (4) are examples in which a part of the time period used by the first base station overlaps the time period of the second base station. In FIGS. 3, (5) and (6) are examples in which the time period used by the first base station and the time period of the second base station do not overlap each other, but a gap between the time periods, for example, a guard time is less than or equal to a predetermined width. In this case, there is a possibility that a rise time and a fall time of the radio wave emitted by the first base station interferes with the second base station.

To summarize the above, the fact that that the first and second base stations use the same time period can be expressed as follows.

$${T}_{2 , Start} \leq {T}_{1 , Start} and {T}_{1 , End} \leq {T}_{2 , End} \qquad ( FIG . 3 ( 1 ) and ( 2 ) )$$

$${T}_{1 , Start} \leq {T}_{2 , Start} and {T}_{2 , Start} \leq {T}_{1 , End} \qquad ( FIG . 3 ( 3 ) )$$

$${T}_{1 , Start} \leq {T}_{2 , End} and {T}_{2 , End} \leq {T}_{1 , End} \qquad ( FIG . 3 ( 4 ) )$$

$$0 \leq {T}_{2 , Start} - {T}_{1 , End} \leq {T}_{1 , 2 , Guard} or 0 \leq {T}_{1 , Start} - {T}_{2 , End} \leq {T}_{1 , 2 , Guard} \qquad ( ( 5 ) and ( 6 ) of FIG . 3 )$$

However, in the above expression, T_{2,Start} and T_{2,End} are the start and end of the time period used by the second base station (T_{2,Start}≤T_{2,End}), T_{1,Start} and T_{1,End} are the start and end of the time period used by the first base station (T_{1,Start}≤T_{1,End}), and T_{1,2,Guard} is a predetermined guard time width (0≤T_{1,2,Guard}) with which the same time period is considered to be used.

### (Prevention or Suppression of Radio Wave Interference Between Base Stations)

In the first embodiment, a case is considered where the first and second base stations (for example, the base stations 22 and 23 of FIG. 1) of the local 5G use the same frequency band by frequency sharing. At this time, in particular, in a case where the first and second base stations are installed close to each other, there is a possibility that radio wave interference occurs between the first and second base stations. The communication control device 30 decides a wireless parameter of at least one of the first or second base station so that radio wave interference does not occur between the first and second base stations.

### (Configuration of Communication Control Device)

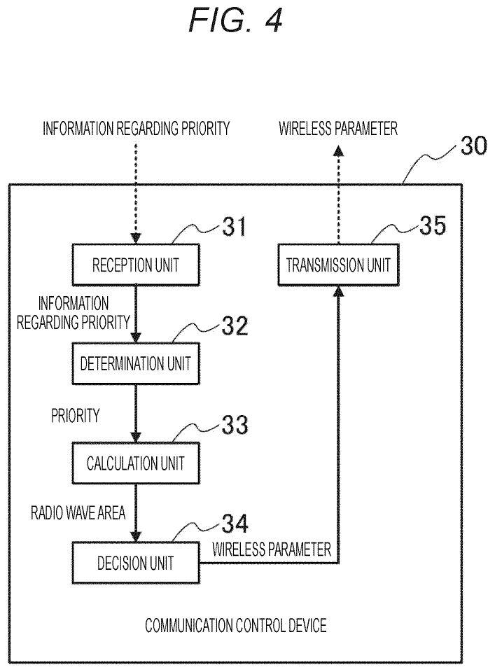

FIG. 4 is a diagram illustrating a detailed configuration of the communication control device 30 according to the first embodiment. The communication control device 30 includes a reception unit 31, a determination unit 32, a calculation unit 33, a decision unit 34, and a transmission unit 35.

The reception unit 31 receives information regarding priority from the first and second base stations. For example, the information regarding the priority includes information such as a use form of a land where the base station is installed and a timing of acquisition of license of the base station.

The determination unit 32 determines the priority between the first and second base stations on the basis of the information regarding the priority of the first and second base stations.

The calculation unit 33 calculates radio wave areas of the first and second base stations on the basis of the priority between the first and second base stations. For example, each radio wave area includes a coverage area and an adjustment target zone.

The decision unit 34 decides the wireless parameter of at least one of the first or second base station on the basis of the radio wave areas calculated by the calculation unit 33. For example, the wireless parameter includes setting information such as maximum transmission power and directivity of a radio wave emitted by the base station.

The transmission unit 36 transmits the wireless parameter to a corresponding base station.

### (Configuration of Base Station)

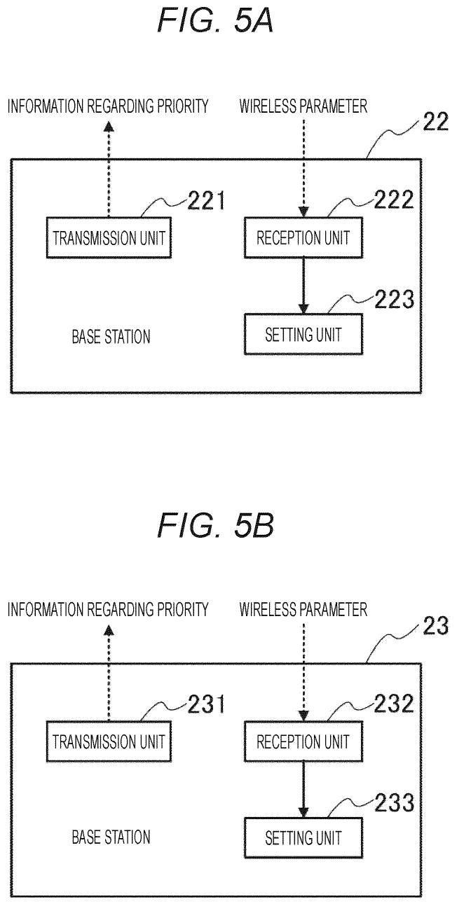

FIG. 5A is a diagram illustrating a detailed configuration of the base station 22 according to the first embodiment. The base station 22 includes a transmission unit 221 that transmits information regarding the priority of the base station 22 to the communication control device 30, a reception unit 222 that receives the wireless parameter from the communication control device 30, and a setting unit 223 that performs operation setting of the base station 22 according to the wireless parameter.

FIG. 5B is a diagram illustrating a detailed configuration of the base station 23 according to the first embodiment. The base station 23 includes a transmission unit 231 that transmits information regarding the priority of the base station 23 to the communication control device 30, a reception unit 232 that receives the wireless parameter from the communication control device 30, and a setting unit 233 that performs operation setting of the base station 23 according to the wireless parameter.

### (Communication Control Protocol Between Communication Control Device and Base Station)

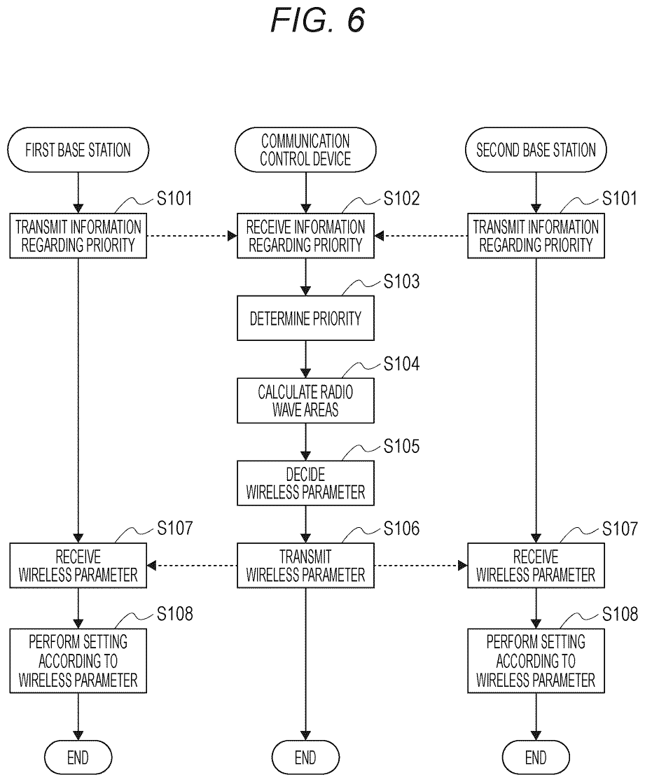

FIG. 6 is a sequence diagram illustrating a communication control protocol between the communication control device 30 and the first and second base stations according to the first embodiment. In the figure, the first base station is, for example, the base station 22 of FIG. 5A, and the second base station is, for example, the base station 23 of FIG. 5B. Furthermore, in the figure, links between the communication control device 30 and the first and second base stations are expressed in a form regardless of whether they are physically directly connected or indirectly connected to each other.

In step S101 of FIG. 6, the transmission units of the first and second base stations transmit information regarding the priority of the first and second base stations to the communication control device 30. For example, the information regarding the priority includes information such as a use form of a land where the base station is installed and a timing of acquisition of license of the base station.

In the first embodiment, ownership of the land is considered as the use form of the land where the base station is installed. Specifically, as the use form of the land where the base station is installed, two methods are considered of one's own land use and other's land use. The one's own land use is, for example, a use form in which a base station is installed on a land for which the one has the ownership. The other's land use is, for example, a use form in which a base station is installed on a land for which the one does not have the ownership. Detailed definitions of the one's own land use and the other's land use will be described later.

In the first embodiment, as the timing of acquisition of license of the base station, three cases are considered: a case where the first base station has already acquired the license of the radio station and the second base station newly applies for the license of the radio station; a case where the second base station has already acquired the license of the radio station and the first base station newly applies for the license of the radio station; and a case where the first and second base stations simultaneously apply for the license of the radio station.

In step S102, the reception unit 31 of the communication control device 30 receives the information regarding the priority transmitted from the first and second base stations in step S101 described above.

In step S103, the determination unit 32 of the communication control device 30 determines the priority between the first and second base stations on the basis of the information regarding the priority of the first and second base stations received in step S102 described above. In the first embodiment, three types of the priority are considered: a case where the first base station has higher priority than the second base station; a case where the second base station has higher priority than the first base station; and a case where the first and second base stations are equal to each other in the priority. For example, a one's own land use base station is determined to have higher priority than an other's land use base station. Details of a method for determining priority will be described later.

In step S104, the calculation unit 33 of the communication control device 30 calculates radio wave areas of the first and second base stations on the basis of the priority between the first and second base stations determined in step S103 described above. In the first embodiment, a radio wave area of a base station includes a plurality of areas (zones) defined on the basis of a received signal strength of a radio wave emitted by the base station. Specifically, the radio wave area includes a coverage area and an adjustment target zone.

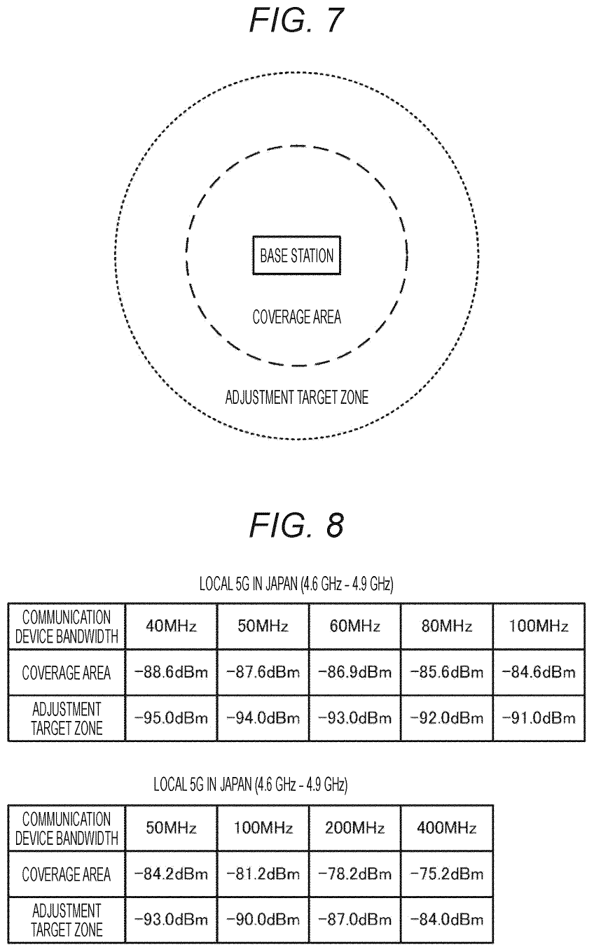

FIG. 7 is an example of the coverage area and the adjustment target zone of the base station. In the figure, each area is circular, but the shape of each area is not limited to a circular shape. The coverage area is an area in which the base station can provide a sufficient communication service to a subordinate terminal device, that is, an area in which the subordinate terminal device can obtain a sufficient received signal strength. The adjustment target zone is an area in which a terminal device subordinate to the base station cannot obtain sufficient received signal strength, but there is a possibility of radio wave interference to a neighboring base station that provides another communication service.

In the first embodiment, the coverage area of the base station having higher priority is calculated so as to be in a minimum necessary range even in a case where it is determined that the priority is higher. The coverage area and the adjustment target zone of the base station having lower priority are calculated so as not to interfere with the coverage area of the base station having higher priority.

FIG. 8 is an example of received signal strengths of the coverage area and the adjustment target zone. In the figure, the received signal strengths of the coverage area and the adjustment target zone are defined according to a frequency of the radio wave emitted by the base station. The received signal strengths of the coverage area and the adjustment target zone may be defined according to a bandwidth of a frequency used by the base station. The received signal strengths of the coverage area and the adjustment target zone may be defined according to a type of a frequency band used by the base station, for example, a frequency band defined by Sub-6 GHZ, Above-6 GHZ, or 3GGP, a frequency range (FR1, FR2, or the like), or the like.

In step S105, the decision unit 34 of the communication control device 30 decides the wireless parameter of at least one of the first or second base station on the basis of the radio wave areas calculated in step S104 described above. In other words, the wireless parameter is decided so that ranges of the radio wave areas calculated in step S104 are achieved. For example, the wireless parameter includes setting information such as maximum transmission power and directivity of the radio wave emitted by the base station.

For example, the maximum transmission power and the directivity are decided so that the received signal strength in the coverage area of the base station is greater than or equal to a predetermined first threshold, and the received signal strength in the adjustment target zone of the base station is less than the predetermined first threshold and greater than or equal to a predetermined second threshold. The first and second thresholds used at this time are set, for example, on the basis of numerical values indicated in FIG. 8.

In step S106, the transmission unit 36 of the communication control device 30 transmits the wireless parameter decided in step S105 to a corresponding base station. Specifically, if only the wireless parameter of the first base station is decided in step S105 described above, the wireless parameter is transmitted only to the first base station. In a case where only the wireless parameter of the second base station is decided in step S105 described above, the wireless parameter is transmitted only to the second base station. In a case where the wireless parameters of the first and second base stations are determined together in step S105 described above, the wireless parameters are transmitted to the first and second base stations.

In step S107, the reception unit of at least one of the first or second base station receives the wireless parameter transmitted from the communication control device 30 in step S106 described above.

In step S108, the setting unit of at least one of the first or second base station performs operation setting of the base station according to the wireless parameter received in step S107 described above. For example, the setting unit of at least one of the first or second base station sets the maximum transmission power, directivity, and the like of the radio wave emitted by the base station according to the wireless parameter.

As described above, the communication control device 30 according to the first embodiment includes the reception unit 31 that receives the information regarding the priority of the first and second base stations, the determination unit 32 that determines the priority between the first and second base stations on the basis of the information regarding the priority, the calculation unit 33 that calculates the radio wave areas of the first and second base stations on the basis of the priority, the decision unit 34 that decides the wireless parameter of at least one of the first or second base station on the basis of the radio wave areas, and the transmission unit 35 that transmits the wireless parameter to the corresponding base station.

With a feature as described above, the radio communication device 30 according to the first embodiment can prevent or suppress radio wave interference between base stations when a plurality of base stations uses the same wireless communication resource.

In particular, in the first embodiment, the ownership of the land where the base station is installed is considered when the priority between the base stations is determined. As a result, for example, it is determined that the base station (one's own land use base station) installed on the land for which the one has the ownership has higher priority than the base station (other's land use base station) installed on the land for which the one does not have the ownership. With such a feature, it is possible to prevent or suppress radio wave interference between base stations in a manner conforming to actual social laws.

(A: Definition of Use Form of Land where Base Station is Installed)

As the use form of the land where the base station is installed, the following two use forms are conceivable on the basis of a relationship between a user of a communication system including the base station and the ownership of the land where the base station is installed. However, the following definitions are merely examples, and are not intended to limit the scope of rights of the present disclosure.

### (A-1: One's Own Land Use)

Principle: The basis is that in one's own building or one's own land, an owner or the like of the building or the land (including a person who has a leasehold right or a land lease right and uses the building or the land. The same applies below.) constructs the communication system by oneself.

Exception: A person who is requested by the owner or the like to construct the communication system can also acquire a radio station license within a range of the request.

### (A-2: Other's Land Use)

Principle: The use of the communication system in a place other than the “one's own land use” described above, that is, in a building, a land, or the like of the other (Except a case where construction of the communication system is requested by an owner or the like of the building or the land.) is limited to the use of fixed communication (in principle, a form in which the base station is used without being moved).

Exception: Under certain conditions as follows, the use form is treated as the one's own land use.
1) A case where a possibility is extremely low that another person constructs the communication system, for the other's land in a narrow area around one's own land, such as a case where a public road, a river, or the like passes through private property sites such as a university campus or a hospital.
2) A case where business is performed integrally on a land of a subscriber by an association to which an owner of a neighboring land joins.

### (B: Method for Determining Priority Between Base Stations and Method for Calculating Radio Wave Area)

In the first embodiment, the priority between the base stations is determined on the basis of the information regarding the priority described above. Specifically, the priority between the base stations is determined on the basis of the use form of the land where the base station is installed and the timing of acquisition of the radio station license related to the base station.

### (B-1: One's Own Land Use Vs Other Company's Land Use)

Regardless of the timing of acquisition of license, it is determined that the one's own land use base station has higher priority than the other's land use base station. The coverage area of the one's own land use base station is calculated so as to be in the minimum necessary range even in a case where it is determined that the priority is higher. The coverage area and the adjustment target zone of the other's land use base station having lower priority are calculated so as not to interfere with the coverage area of the one's own land use base station having higher priority.

### (B-2: One's Own Land Use Vs One's Own Land Use)

Regardless of the timing of acquisition of license, it is determined that the two base stations are equal to each other in the priority. In this case, for example, the priority is determined through consultation between parties concerned. In this case, the coverage area of the base station having higher priority is calculated so as to be in the minimum necessary range even in a case where it is determined that the priority is higher. The coverage area and the adjustment target zone of the base station having lower priority are calculated so as not to interfere with the coverage area of the base station having higher priority.

### (B-3: Other's Land Use Vs Other's Land Use)

It may be determined that a base station having an earlier timing of acquisition of license has higher priority. In this case, the coverage area of the base station having higher priority is calculated so as to be in the minimum necessary range even in a case where it is determined that the priority is higher. The coverage area and the adjustment target zone of the base station having lower priority are calculated so as not to interfere with the coverage area of the base station having higher priority.

### (C: Typical Case)

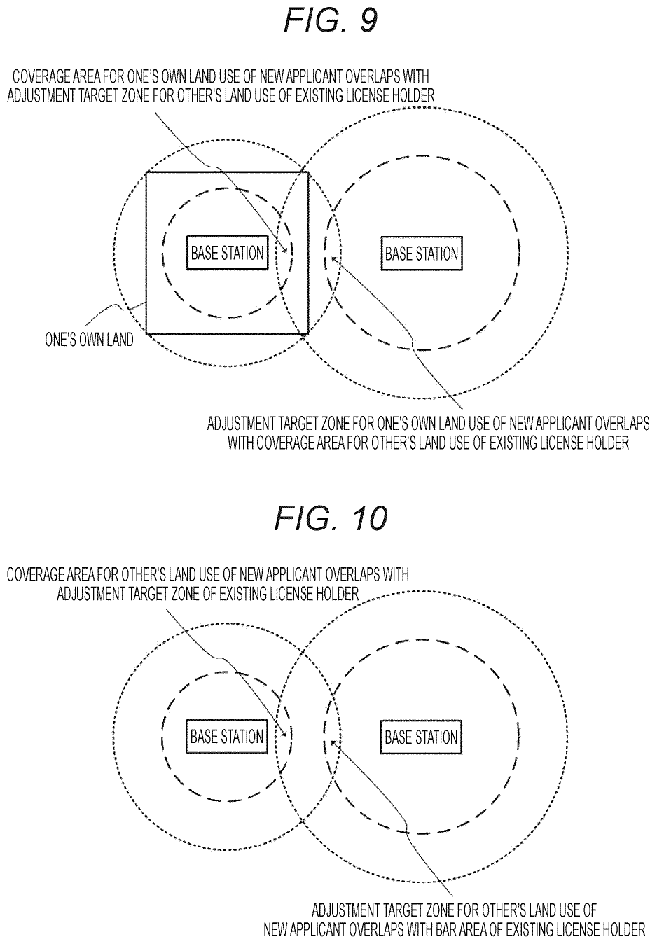

FIG. 9 illustrates an example of a case where there is already an other's land use base station in the vicinity when a one's own land use base station is newly installed. In a case where the coverage area or the adjustment target zone overlaps with that of a neighboring other's land use base station, it is necessary to hold a consultation before applying for license of a radio station.

For example, the following two cases are considered as cases in which an applicant for the one's own land use needs to give a notification in advance to an existing license holder and respond in a case where consultation is requested from the license holder.
Case 1: Case where coverage area for one's own land use of new applicant overlaps with adjustment target zone for other's land use of existing license holder
Case 2: Case where adjustment target zone for one's own land use of new applicant overlaps with coverage area for other's land use of existing license holder

In the case of any of the cases described above, the existing license holder of the other's land use takes necessary measures so as not to cause overlap, except a case where both parties agree individually. Note that, in a case where the adjustment target zone for the one's own land use of the new applicant and the adjustment target zone for the other company's land use of the existing license holder overlap each other, preliminary consultation is not necessarily required, but both parties hold consultation as necessary.

FIG. 10 illustrates an example of a case where there is already another base station in the vicinity when an other's land use base station is newly installed. In a case where the coverage area or the adjustment target zone overlaps with that of the neighboring base station, it is necessary to hold a consultation before applying for license of a radio station.

For example, in the case of the local 5G, the one's own land use is prioritized over the other's land use. For that reason, the applicant for the other's land use can apply only at a place where a one's own land use base station is not installed.

In a case where the coverage area for the other's land use of the new applicant overlaps with the adjustment target zone for the one's own land use or the other's land use of the existing license holder, it is possible to make an application in consideration of a possibility of harmful interference in business execution of the applicant. Note that, as necessary, a consultation is held with the existing license holder.

In a case where the adjustment target zone for the other's land use of the new applicant overlaps with the coverage area for the one's own land use or the other's land use of the existing license holder, the license is not granted except a case where it is clear that there is no harmful interference in business execution of the existing license holder.

### CONCLUSION

The technology according to the present disclosure is not limited to a specific standard, and the exemplified setting may be appropriately modified. Note that each of the above-described examples illustrates an example for embodying the present disclosure, and the present disclosure can be implemented in other various forms. For example, various modifications, substitutions, omissions, combinations, or the like can be made without departing from the gist of the present disclosure. Forms with such modifications, substitutions, omissions, combinations, or the like are also included in the scope of the present disclosure and are included in the invention described in the claims and the equivalent scope thereof.

Procedures of processing described in the present disclosure may be regarded as a method including a series of these procedures. Alternatively, the procedures may be regarded as a program for causing a computer to execute the series of these procedures, or a recording medium storing the program. Furthermore, the processing described above is executed by a processor such as a CPU of a computer. Furthermore, a type of the recording medium is not particularly limited since it does not affect the examples of the present disclosure.

Each of components described in the present disclosure may be implemented by software or hardware. For example, each component may be a software module implemented by software such as a microprogram, and each component may be implemented by the processor executing the software module. Alternatively, each component may be implemented by a circuit block on a semiconductor chip (die), for example, an integrated circuit such as an application specific integrated circuit (ASIC) or a field programmable gate array (FPGA). Furthermore, the number of components and the number of pieces of hardware for implementing the components may not coincide with each other. For example, one processor or circuit may implement a plurality of components. Conversely, one component may be implemented by a plurality of processors or circuits.

A type of the processor described in the present disclosure is not limited. For example, the processor may be a CPU, a micro processing unit (MPU), a graphics processing unit (GPU), or the like.

The present disclosure can also have the following configurations.
[Item 1] (Communication control device)

A communication control device including:
a first reception unit that receives information regarding priority of a first base station and a second base station;
a determination unit that determines priority between the first base station and the second base station on the basis of the information regarding the priority;
a calculation unit that calculates radio wave areas of the first base station and the second base station on the basis of the priority;
a decision unit that decides a wireless parameter of at least one of the first base station or the second base station on the basis of the radio wave areas; and a first transmission unit that transmits the wireless parameter to a corresponding base station.
[Item 2]

The communication control device according to item 1, in which the information regarding the priority includes a use form of a land where the base station is installed.
[Item 3]

The communication control device according to item 2, in which the use form of the land is decided in consideration of ownership of the land.
[Item 4]

The communication control device according to item 2 or 3, in which the information regarding the priority further includes a timing of acquisition of license of the base station.
[Item 5]

The communication control device according to any one of items 1 to 4, in which the radio wave areas include a coverage area.
[Item 6]

The communication control device according to item 5, in which the radio wave areas further include an adjustment target zone.
[Item 7]

The communication control device according to item 6, in which
the wireless parameter includes at least one of maximum transmission power or directivity of a radio wave emitted by the base station, and
the at least one of the maximum transmission power or the directivity is decided to cause received signal strength in the coverage area to be greater than or equal to a predetermined first threshold, and received signal strength in the adjustment target zone to be less than the predetermined first threshold and greater than or equal to a predetermined second threshold.
[Item 8]

The communication control device according to item 1, in which the first base station and the second base station are local 5G base stations.
[Item 9] (Base station)

A base station including:
a second transmission unit that transmits information regarding priority of the base station to a communication control device;
a second reception unit that receive a wireless parameter from the communication control device; and
a setting unit that performs operation setting of the base station according to the wireless parameter.
[Item 10] (Communication control method)

A communication control method including:
a step of receiving information regarding priority of a first base station and a second base station;
a step of determining priority between the first base station and the second base station on the basis of the information regarding the priority;
a step of calculating radio wave areas of the first base station and the second base station on the basis of the priority;
a step of deciding a wireless parameter of at least one of the first base station or the second base station on the basis of the radio wave areas; and
a step of transmitting the wireless parameter to a corresponding base station.

### REFERENCE SIGNS LIST

10 Primary system
11 Core network
12 Base station
13 Terminal device
20 Secondary system
21 Core network
22 Base station (first base station)
221 Transmission unit (second transmission unit)
222 Reception unit (second reception unit)
223 Setting unit
23 Base station (second base station)
231 Transmission unit (second transmission unit)
232 Reception unit (second reception unit)
233 Setting unit
24 Terminal device
25 Terminal device
30 Communication control device
31 Reception unit (first reception unit)
32 Determination unit
33 Calculation unit
34 Decision unit
35 Transmission unit (first transmission unit)
50 Internet line
60 Information recording device

1. A communication control device comprising:
a first reception unit that receives information regarding priority of a first base station and a second base station;
a determination unit that determines priority between the first base station and the second base station on a basis of the information regarding the priority;
a calculation unit that calculates radio wave areas of the first base station and the second base station on a basis of the priority;
a decision unit that decides a wireless parameter of at least one of the first base station or the second base station on a basis of the radio wave areas; and
a first transmission unit that transmits the wireless parameter to a corresponding base station.

2. The communication control device according to claim 1, wherein the information regarding the priority includes a use form of a land where the base station is installed.

3. The communication control device according to claim 2, wherein the use form of the land is decided in consideration of ownership of the land.

4. The communication control device according to claim 2, wherein the information regarding the priority further includes a timing of acquisition of license of the base station.

5. The communication control device according to claim 1, wherein the radio wave areas include a coverage area.

6. The communication control device according to claim 5, wherein the radio wave areas further include an adjustment target zone.

7. The communication control device according to claim 6, wherein
the wireless parameter includes at least one of maximum transmission power or directivity of a radio wave emitted by the base station, and
the at least one of the maximum transmission power or the directivity is decided to cause received signal strength in the coverage area to be greater than or equal to a predetermined first threshold, and received signal strength in the adjustment target zone to be less than the predetermined first threshold and greater than or equal to a predetermined second threshold.

8. The communication control device according to claim 1, wherein the first base station and the second base station are local 5G base stations.

9. A base station comprising:
a second transmission unit that transmits information regarding priority of the base station to a communication control device;
a second reception unit that receive a wireless parameter from the communication control device; and
a setting unit that performs operation setting of the base station according to the wireless parameter.

10. A communication control method comprising:
a step of receiving information regarding priority of a first base station and a second base station;
a step of determining priority between the first base station and the second base station on a basis of the information regarding the priority;
a step of calculating radio wave areas of the first base station and the second base station on a basis of the priority;
a step of deciding a wireless parameter of at least one of the first base station or the second base station on a basis of the radio wave areas; and
a step of transmitting the wireless parameter to a corresponding base station.
